(19) United States
(12) Patent Application Publication
(10) Pub. No.: US 2026/0258735 A1
(43) Pub. Date: Sep. 3, 2026

(54) HYBRID ENGINE SYSTEM

(71) Applicant: General Electric Company, Evendale, OH (US)

(72) Inventors: Jeffrey D. Rambo, Mason, OH (US); Kurt D. Murrow, Dayton, OH (US); Darek Zatorski, Fort Wright, KY (US)

(21) Appl. No.: 19/067,081

(22) Filed: Feb. 28, 2025

(51) Int. Cl. F01D 15/10; B64D 27/33; F02C 6/00

(52) U.S. Cl. CPC F01D 15/10; B64D 27/33; F02C 6/00; B64D 2221/00; F05D 2220/76

(57) ABSTRACT

A hybrid engine system including a turbine engine having a fan section, a compressor section, a combustion section, a turbine section, a shaft coupled to the compressor section, and a nacelle circumferentially surrounding the fan section. A duct extends from the nacelle upstream of the fan section. An electrical power generator is mechanically coupled to the shaft, the electrical power generator being configured to convert at least a portion of mechanical power generated by the turbine engine into electrical power. A part-span inlet guide vane is disposed between the duct and the nacelle, the part-span inlet guide vane including a plurality of inlet guide vanes that are configured to rotate to adjust an amount of pressure of the airflow towards the fan section.

### TECHNICAL FIELD

The present disclosure relates generally a hybrid engine system.

### BACKGROUND

Turbine engines generally include a fan and a turbomachine arranged in flow communication with one another. The fan includes a plurality of airfoils or blades coupled to a rotor assembly. A turbine engine can be converted into a hybrid engine system by operationally coupling an electrical power generator to the turbine engine.

### BRIEF DESCRIPTION OF THE DRAWINGS

Features and advantages will be apparent from the following, more particular, description of various exemplary embodiments, as illustrated in the accompanying drawings, wherein like reference numbers generally indicate identical, functionally similar, and/or structurally similar elements.

FIG. 1 is a schematic, cross-sectional diagram of a hybrid engine system including a turbine engine and an electrical power generator, according to an embodiment of the present disclosure.

FIG. 2 is a flow diagram of a system of converting mechanical energy from the turbine engine to the electrical power generator and to an electric motor.

### DETAILED DESCRIPTION

Features, advantages, and embodiments of the present disclosure are set forth or apparent from a consideration of the following detailed description, drawings, and claims. Moreover, both the foregoing summary of the present disclosure and the following detailed description are exemplary and intended to provide further explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the present disclosure.

As used herein, the terms “first” and “second” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “low” and “high,” or their respective comparative degrees (e.g., “lower” and “higher,” where applicable), when used with the compressor, turbine, shaft, or spool components, each refers to relative pressures and/or relative speeds within an engine unless otherwise specified. For example, a “low-speed” component defines a component configured to operate at a rotational speed, such as a maximum allowable rotational speed, which is lower than that of a “high-speed” component of the engine. Alternatively, unless otherwise specified, the afore mentioned terms may be understood in their superlative degree. For example, a “low-pressure turbine” may refer to the lowest maximum pressure within a turbine section, and a “high-pressure turbine” may refer to the highest maximum pressure within the turbine section. The terms “low” or “high” in such afore mentioned regards may additionally, or alternatively, be understood as relative to minimum allowable speeds and/or pressures, or minimum or maximum allowable speeds and/or pressures relative to normal, desired, steady state, etc., operation of the engine.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the term “axial” refers to directions and orientations that extend substantially parallel to a longitudinal centerline of the turbine engine. Moreover, the terms “radial” and “radially” refer to directions and orientations that extend substantially perpendicular to the longitudinal centerline of the turbine engine. In addition, as used herein, the term “circumferentially” refers to directions and orientations that extend arcuately about the longitudinal centerline of the turbine engine.

The present disclosure provides a hybrid engine system having a turbo-electric convertible engine architecture including a part-span inlet guide vane (PSIGV) and an electrical power generator.

The hybrid engine system modifies an existing turbine engine without modifying the existing turbine engine flow paths. An electrical power generator is provided upstream of the fan and is coupled to the fan. The PSIGV flow is provided upstream of the turbine engine inlet for off-loading the fan and transfer mechanical power from the turbine engine to the electrical power generator.

The hybrid engine system combines a turbine engine and an electrical power generator in a single system without significant hardware changes to the turbine engine. As a result, propulsion system development time is reduced by converting existing turbine engines and using and electrical power generator within an inlet duct.

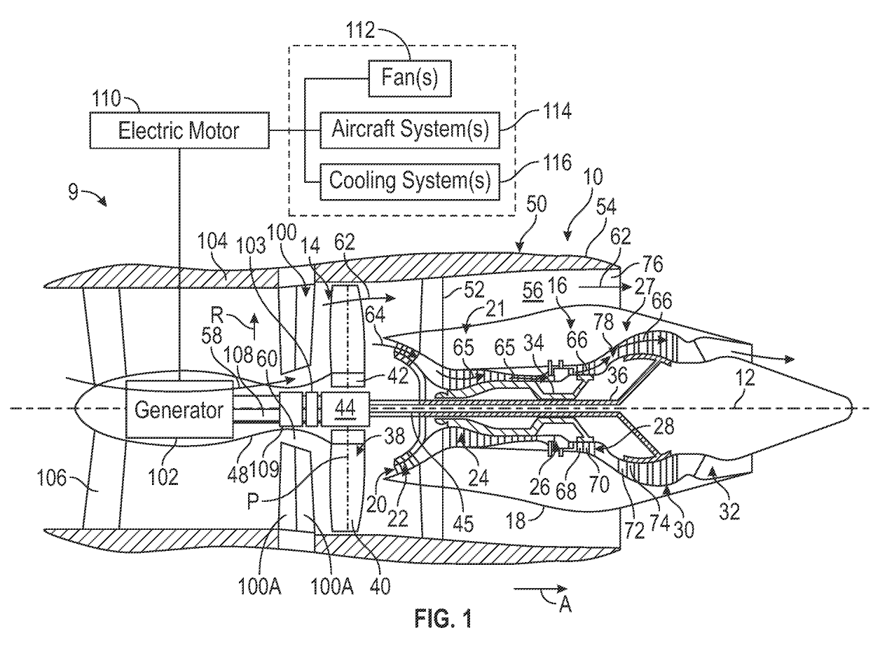

Referring now to the drawings, FIG. 1 is a schematic, cross-sectional diagram of a hybrid engine system 9 including a turbine engine 10 and an electrical power generator 102, according to an embodiment of the present disclosure. As shown in FIG. 1, the turbine engine 10 of the hybrid engine system 9 defines an axial direction A (extending parallel to a longitudinal centerline axis 12 provided for reference) and a radial direction R that is normal to the axial direction A. In general, the turbine engine 10 includes a fan section 14 and a turbo-engine 16 disposed downstream from the fan section 14.

The turbo-engine 16 depicted in FIG. 1 generally includes an outer casing 18 that is substantially tubular and defines an annular inlet 20. As schematically shown in FIG. 1, the outer casing 18 encases, in serial flow relationship, a compressor section 21 including a booster or a low-pressure (LP) compressor 22 followed downstream by a high-pressure (HP) compressor 24, a combustion section 26, a turbine section 27 including a high-pressure (HP) turbine 28 followed downstream by a low-pressure (LP) turbine 30, and a jet exhaust nozzle section 32. A high-pressure (HP) shaft 34 or a spool drivingly connects the HP turbine 28 to the HP compressor 24, to rotate the HP turbine 28 and the HP compressor 24 in unison. A low-pressure (LP) shaft 36 or a spool drivingly connects the LP turbine 30 to the LP compressor 22, to rotate the LP turbine 30 and the LP compressor 22 in unison. The compressor section 21, the combustion section 26, the turbine section 27, and the jet exhaust nozzle section 32 together define a core air flowpath.

For the embodiment depicted in FIG. 1, the fan section 14 includes a fan 38 (e.g., a variable pitch fan) having a plurality of fan blades 40 (airfoils) coupled to a disk 42 in a spaced apart manner. As depicted in FIG. 1, the fan blades 40 extend outwardly from the disk 42 generally along the radial direction R. Each fan blade 40 is rotatable relative to the disk 42 about a pitch axis P by virtue of the fan blades 40 being operatively coupled to an actuation member 44 configured to collectively vary the pitch of the fan blades 40 in unison. The fan blades 40, the disk 42, and the actuation member 44 are together rotatable about the longitudinal centerline axis 12 via a fan shaft 45 that is powered by the LP shaft 36. The disk 42 is covered by a fan hub 48 aerodynamically contoured to promote an airflow through the plurality of fan blades 40. The fan hub 48 is rotatable.

The fan section 14 includes an annular fan casing or a nacelle 50 that circumferentially surrounds the fan 38 and/or at least a portion of the turbo-engine 16. The nacelle 50 is supported relative to the turbo-engine 16 by a plurality of circumferentially spaced outlet guide vanes 52. Moreover, a downstream section 54 of the nacelle 50 extends over an outer portion of the turbo-engine 16 to define a bypass airflow passage 56 therebetween.

Referring still to the embodiment of FIG. 1, the hybrid engine system 9 includes a duct 104. The duct 104 extends from the nacelle 50 upstream of the fan section 14. The duct 104 circumferentially surrounds the fan hub 48. The duct 104 is supported by a plurality of circumferentially spaced outer vanes 106. The plurality of circumferentially spaced outer vanes 106 are coupled to the fan hub 48.

The hybrid engine system 9 also includes a part-span inlet guide vane (PSIGV) 100. The part-span inlet guide vane 100 is provided between the duct 104 and the nacelle 50. The part-span inlet guide vane 100 is disposed upstream of the fan section 14. The part-span inlet guide vane 100 operates as a variable airflow inlet guide vane to control airflow angle to the fan blades in the fan section 14. The part-span inlet guide vane 100 has also a variable inlet 60 that is configured to control an amount of work imparted to the airflow by the fan section 14, resulting in a low pressure rise to approximately the same amount of airflow. In an embodiment, the part-span inlet guide vane 100 includes inlet guide vanes 100A that are rotatable to control an amount of airflow and direction and thus pressure towards the fan section 14. Rotating the inlet guide vanes 100A of the part-span inlet guide vane will result in a different physical and effective flow area by directing the airflow to or away from the fan section 14.

In this embodiment, incoming airflow 58 is split into an inner radial airflow that passes through the variable inlet 60 and an outer radial airflow that passes between the inlet guide vanes 100A of the part-span inlet guide vane 100. In another embodiment, the part-span inlet guide vane 100 may not be provided with the variable inlet 60. In this case, the incoming airflow 58 is not split and is regulated by the inlet guide vanes 100A of the part-span inlet guide vane 100.

As shown in FIG. 1, the hybrid engine system 9 also includes an electrical power generator 102 located within the fan hub 48 between the part-span inlet guide vane 100 and the plurality of circumferentially spaced outer vanes 106. The electrical power generator 102 is connected to the fan shaft 45 via a transmission shaft 108. In an embodiment, the electrical power generator 102 is aligned with the longitudinal centerline axis 12 of the turbine engine 10. A rotation of the fan shaft 45 can be transmitted to the transmission shaft 108, which, then, provides mechanical power to the electrical power generator 102. The electrical power generator 102 is configured to convert mechanical power into electrical power. The electrical power generator 102 is mechanically coupled to the fan shaft 45 and is configured to convert at least a portion of mechanical power generated by the turbine engine 10 into electrical power. The electrical power generator 102 is shown being connected to the fan shaft 45 via the transmission shaft 108 and, thus, is provided upstream of the turbine engine 10. In an embodiment, the fan shaft 45 is a transmission shaft.

During operation of the turbine engine 10, a volume of airflow 58 enters the turbine engine 10 through the variable inlet 60 in the part-span inlet guide vane 100. The part-span inlet guide vane 100 changes a turning angle of the inlet guide vanes 100A (e.g., the inlet airflow is aligned to the axial direction without a circumferential angle) into the fan blades 40 to adjust the amount of pressure of the airflow 58 towards the fan blades 40. As a result, the fan 38 does not pressurize the airflow as intended due incoming airflow towards the fan blades 40 making an angle relative to the fan blades 40 different from a normal operation angle of airflow. The part-span inlet guide vane 100 only affects the power transfer to the airflow through the upper portion of fan blades 40 to the fan duct 56 while the lower portion of the fan blades 40 (facing the variable inlet 60) flow and pressure rise remains unchanged into the turbo-engine 16 by varying PSIV position. The term “normal operation angle of airflow” is used herein to mean an airflow that generates pressure on the fan blades 40 so that the turbine engine 10 generates thrust.

As the volume of airflow 58 passes across the fan blades 40 (rotating airfoils), a first portion of airflow 62 is directed or routed into the bypass airflow passage 56, and a second portion of airflow 64 is directed or is routed into the upstream section of the core air flowpath, or, more specifically, into the annular inlet 20 of the LP compressor 22. The ratio between the first portion of the airflow 62 and the second portion of the airflow 64 is commonly known as a bypass ratio. The pressure of the second portion of the airflow 64 is then increased, generating compressed air 65, and the compressed air 65 is routed through the HP compressor 24 and into the combustion section 26, where the compressed air 65 is mixed with fuel and burned to generate combustion gases 66.

The combustion gases 66 are routed into the HP turbine 28 and expanded through the HP turbine 28 where a portion of thermal energy or kinetic energy, or both, from the combustion gases 66 is extracted via sequential stages of HP turbine stator vanes 68 (stator airfoils) that are coupled to the outer casing 18 and HP turbine rotor blades 70 (rotating airfoils) that are coupled to the HP shaft 34, thus, causing the HP shaft 34 to rotate, thereby supporting operation of the HP compressor 24. The combustion gases 66 are then routed into the LP turbine 30 and expanded through the LP turbine 30. Here, a second portion of the thermal energy of the kinetic energy, or both, is extracted from the combustion gases 66 via sequential stages of LP turbine stator vanes 72 (stator airfoils) that are coupled to the outer casing 18 and LP turbine rotor blades 74 (rotating airfoils) that are coupled to the LP shaft 36, thus, causing the LP shaft 36 to rotate, thereby supporting operation of the LP compressor 22 and rotation of the fan 38.

The combustion gases 66 are subsequently routed through the jet exhaust nozzle section 32 of the turbo-engine 16. Simultaneously, the pressure of the first portion of the airflow 62 is substantially increased as the first portion of the airflow 62 is routed through the bypass airflow passage 56 before being exhausted from a fan nozzle exhaust section 76 of the turbine engine 10, also providing propulsive thrust. The HP turbine 28, the LP turbine 30, and the jet exhaust nozzle section 32 at least partially define a hot gas path 78 for routing the combustion gases 66 through the turbo-engine 16.

The turbine engine 10 depicted in FIG. 1 is by way of example only. In other exemplary embodiments, the turbine engine 10 may have any other suitable configuration. For example, in other exemplary embodiments, the fan 38 may be configured in any other suitable manner (e.g., as a fixed pitch fan) and further may be supported using any other suitable fan frame configuration. Moreover, in other embodiments, any other suitable number or configuration of compressors, turbines, shafts, or a combination thereof may be provided. In still other embodiments, aspects of the present disclosure may be incorporated into any other suitable turbine engine, such as, for example, turbofan engines, propfan engines, turbojet engines, turboprop, and/or turboshaft engines.

The part-span inlet guide vane 100 can be configured to reduce the power transfer from the low pressure rotor (LP compressor) to the airflow. This can result in reducing the fan pressure ratio and net thrust of the turbo-engine 16. The part-span inlet guide vane 100 can also be configured to be opened to increase the amount of airflow 58 towards the fan 38 to enable the turbine engine 10 to generate thrust. The inlet guide vanes 100A of the part-span inlet guide vane 100 can be rotated to offload the power consumed by the fan 38. A clutch or transmission may be used to mechanically decouple the electrical power generator 102 from low pressure turbine to reduce that power consumption by the fan 38 and apply the complete power developed by the LP turbine 30 onto the fan blades 40. In an embodiment, the opening, or the closing, or both, of the part-span inlet guide vane 100 can be effectuated by changing a pitch of the part-span inlet guide vane 100. For example, the part-span inlet guide vane 100 changes a turning angle of the inlet guide vanes 100A (e.g., the inlet airflow is aligned to the axial direction without a circumferential angle) into the fan blades 40 to adjust the amount of airflow 58 towards the fan blades 40. As a result, the fan 38 does not pressurize the airflow as intended. The part-span inlet guide vane 100 only affects the power transfer to the airflow through the upper portion of fan blade to the fan duct 56 while the lower portion of the fan blade (facing the variable inlet 60) flow and pressure rise remains unchanged into the turbo-engine 16 by varying PSIV position.

When the amount of pressure generated by airflow 58 towards the fan 38 is decreased due to an orientation of the inlet guide vanes 100A of the part-span inlet guide vane 100, the fan 38 is considered to not pressurize airflow. When the amount of pressure generated by the airflow 58 towards the fan 38 is increased due to a normal orientation of the inlet guide vanes 100A to provide normal operation angle of airflow, the fan 38 is considered to pressurize airflow. When the fan 38 is pressurizing airflow, the power, or the torque of the turbine engine 10 is directed towards the electrical power generator 102 to generate electrical power. The electrical power generated by the electrical power generator can be stored in one or more batteries or transmitted directly to power electrical components or electrical equipment.

For example, torque from the turbine engine 10 can be taken off the fan 38 and transferred instead to the electrical power generator 102 during vertical takeoff and landing (VTOL), or in-flight hover. For example, if an aircraft (not shown) has a plurality of hybrid engine systems 9, one or more of the plurality of hybrid engine systems 9 can be used mainly to transfer torque from the turbine engine 10 to the electrical power generator 102 to generate electrical power to power electrical equipment of the aircraft, while a remaining one or more hybrid engine systems 9 can be used to transfer torque from the turbine engine 10 to the fan 38 to provide propulsion or forward thrust to the aircraft.

In an embodiment, a clutch 103 can be used to couple the fan to the electrical power generator 102 or to decouple the fan 38 from the electrical power generator 102. In an embodiment, the clutch 103 can be a mechanical clutch or an electromagnetic clutch. For example, the clutch 103 can be provided between the fan 38 and the electrical power generator 102. For example, the clutch 103 can be provided between the transmission shaft 108 and the fan 38. By providing a clutch, the fan 38 can continue rotating while the rotation of the electrical power generator is halted. Alternatively, or in addition, a gearbox 109 can be provided between the fan 38 and the electrical power generator 102. For example, the gearbox 109 can be provided between the transmission shaft 108 and the fan 38. The gearbox 109 enables rotating the electrical power generator 102 at a different rotation speed than that of the fan 38, if needed. For example, the fan 38 can rotate at a first rotation speed, and the electrical power generator 102 can rotate at a second rotation speed less than the first rotation speed.

The mechanical energy generated by the turbine engine 10 is at least partially transferred to the electrical power generator 102 to generate electrical power. At least a portion of the electrical power generated by the electrical power generator 102 is transferred to an electric motor 110. The electric motor 110 is connected to various equipment or auxiliary systems including one or more fans 112, one or more aircraft systems 114, or one or more cooling systems 116, or any combination thereof to operate the equipment. The hybrid engine system 9 is well-suited for vertical take-off and landing vehicles that are also capable of higher speed flight because the offloading of the fan power when used for the electrical power generator 102 greatly reduces the thrust (near zero) of the turbine engine 10. The electrical power generated by the electrical power generator 102 is transferred to lift fans to power the hoovering of an aircraft. This enables a traditional fixed-wing aircraft (e.g., business jet, light commuter airplane, etc.) to hoover and execute vertical take-off and landing maneuvers.

In an embodiment, the part-span inlet guide vane 100 can be configured to generate pre-swirling of the incoming airflow 58 approaching the fan blades 40 in a favorable manner. For example, pre-swirling the outer radial airflow of the incoming airflow 58 that passes between the inlet guide vanes 100A at the outermost portions of the fan inlet duct can reduce flow separation losses or shock losses, or both, on the fan blades 40. This enables the fan 38 to operate at higher fan tip speeds with less efficiency loss. In an embodiment, the part-span inlet guide vane 100 can also be configured to reduce the turbulence levels of the inner radial airflow that passes through the variable inlet 60 at the radial inboard location.

In an embodiment, the inlet guide vanes 100A of the part-span inlet guide vane 100 can be rotated and oriented to produce an aerodynamically unfavorable inlet airflow angle to the fan 38 to reduce the fan power to the airflow 58 when the hybrid engine system 9 is configured to operate in power generation mode so that mechanical power is transferred from the turbine engine 10 to the electrical power generator 102.

In an embodiment, the inlet guide vanes 100A of the part-span inlet guide vane 100 can be rotated and oriented to produce an aerodynamically favorable inlet airflow angle to the fan 38 to increase the fan aerodynamic efficiency when the hybrid engine system 9 is configured to operate in thrust mode. In an embodiment, an aerodynamic shape of the inlet guide vanes 100A of the part-span inlet guide vane 100 may vary along a length of the inlet guide vanes 100A, such that a chord line of the inlet guide vanes, a camber line of the inlet guide vanes, turning angles of the inlet guide vanes, etc., may vary along the radial direction R.

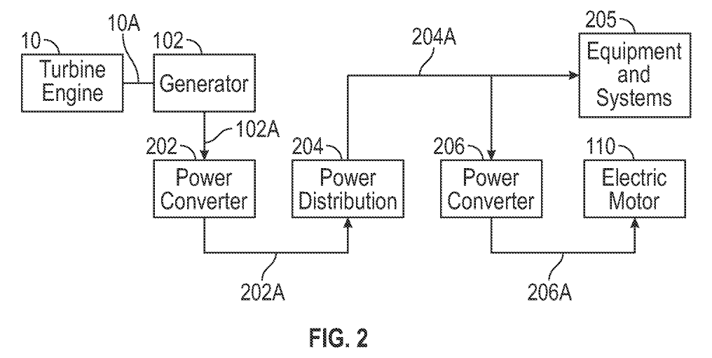

FIG. 2 is a flow diagram of a system of converting mechanical energy from the turbine engine 10 to the electrical power generator 102, and transferring electrical power from the electrical power generator 102 to the electric motor 110 shown in FIG. 1, according to an embodiment of the present disclosure. As shown in FIG. 2, the turbine engine 10 provides mechanical power 10A to the electrical power generator 102. The electrical power generator 102 converts at least a portion of the mechanical power 10A from the turbine engine 10 into electrical power 102A. By converting the mechanical power into electrical power, it is possible to transmit the electrical power using electrical cables or wires to equipment at specific locations. As a result, instead of transferring mechanical power using mechanical components (e.g., gears, etc.) or airflow, electrical power can be used instead to allow more flexibility in transporting power to desired equipment at specific locations. The electrical power 102A generated by the electrical power generator 102 is output to power converter 202. The power converter 202 is configured to convert power from alternative current (AC) to direct current (DC) or vice versa, or to convert high voltage to low voltage or vice versa, or convert frequency, etc. to output converted electrical power 202A. The converted electrical power 202A output by the power converter 202 is, in turn, input to power distribution system 204. The power distribution system 204 regulates and distributes electrical power 204A to various equipment and systems 205 in an aircraft. Distributed electrical power 204A from power distribution system 204 may optionally be power converted (e.g., voltage converted, current converted, or frequency converted, or any combination thereof) using a power converter 206. The power converter 206 outputs converted electrical power 206A for inputting to the electric motor 110 to power the electric motor 110. In the case when the electrical power from the electrical power generator 102 is distributed to vertical lift fans throughout the aircraft, then a power conversion and distribution system is used. In an embodiment, the hybrid engine system 9 can be one of a plurality of engine systems that may be converted to generate electrical power demanded by the vehicle (aircraft) at the expense of thrust. One or more remaining hybrid engine systems in the plurality of engine systems may be used solely for thrust, if desired.

The hybrid engine system modifies an existing turbine engine without modifying the existing turbine engine flow paths. An electrical power generator is provided upstream of the fan and is coupled to the fan. The PSIGV flow is provided upstream of the turbine engine inlet for off-loading the fan and transfer mechanical power from the turbine engine to the electrical power generator.

The hybrid engine system combines a turbine engine and an electrical power generator in a single system without significant hardware changes to the turbine engine. As a result, propulsion system development time is reduced by converting existing turbine engines and using and electrical power generator within an inlet duct.

Further aspects are provided by the subject matter of the following clauses.

A hybrid engine system includes a turbine engine having a fan section, a compressor section, a combustion section, a turbine section, a shaft coupled to the compressor section, and a nacelle circumferentially surrounding the fan section, a duct extending from the nacelle upstream of the fan section, an electrical power generator mechanically coupled to the shaft, the electrical power generator being configured to convert at least a portion of mechanical power generated by the turbine engine into electrical power, and a part-span inlet guide vane disposed between the duct and the nacelle. The part-span inlet guide vane includes a plurality of inlet guide vanes that are configured to rotate to adjust an amount of pressure of the airflow towards the fan section.

The hybrid engine system of the preceding clause, the turbine engine defining a longitudinal centerline axis and the electrical power generator is aligned with the longitudinal centerline axis.

The hybrid engine system of any preceding clause, the electrical power generator being connected to the shaft via a transmission shaft.

The hybrid engine system of any preceding clause, the shaft is a transmission shaft.

The hybrid engine system of any preceding clause, the part-span inlet guide vane being configured to be closed to reduce the amount of pressure of airflow on the fan section to transfer power to the electrical power generator.

The hybrid engine system of any preceding clause, the part-span inlet guide vane being configured to be opened to increase the amount of pressure of airflow on the fan section to enable the turbine engine to generate thrust.

The hybrid engine system of any preceding clause, the part-span inlet guide vane being disposed upstream of the fan section.

The hybrid engine system of any preceding clause, the compressor section includes a low-pressure compressor, the turbine section includes a low-pressure turbine, and the fan section includes a fan shaft. The fan shaft is coupled to a low-pressure shaft, and the low-pressure shaft connects the low-pressure turbine to the low-pressure compressor to rotate the low-pressure turbine and the low-pressure compressor in unison.

The hybrid engine system of any preceding clause, the shaft including a fan shaft coupled to a fan in the fan section, and the electrical power generator is mechanically coupled to the fan shaft.

The hybrid engine system of any preceding clause, the electrical power generator being configured to output at least a portion of the electrical power generated by the electrical power generator to charge one or more batteries.

The hybrid engine system of any preceding clause, further including a clutch provided between a fan of the fan section and the electrical power generator to couple the fan to the electrical power generator or to decouple the fan from the electrical power generator.

The hybrid engine system of any preceding clause, further including a gearbox provided between a fan of the fan section and the electrical power generator to enable rotating the electrical power generator at a different rotation speed than the fan.

The hybrid engine system of any preceding clause, the fan section including a fan having a plurality of fan blades coupled to a disk in a spaced apart manner, the disk being covered by a fan hub.

The hybrid engine system of any preceding clause, the electrical power generator being located inside the fan hub, and the duct circumferentially surrounds the fan hub.

The hybrid engine system of any preceding clause, the duct being supported by a plurality of circumferentially spaced outer vanes, the plurality of circumferentially spaced outer vanes are coupled to the fan hub.

The hybrid engine system of any preceding clause, the electrical power generator being configured to output at least a portion of the electrical power generated by the electrical power generator to an electric motor.

The hybrid engine system of any preceding clause, the electric motor being connected to equipment to operate the equipment.

The hybrid engine system of any preceding clause, the equipment including one or more fans, one or more aircraft systems, or one or more cooling systems, or any combination thereof.

The hybrid engine system of any preceding clause, the electrical power generated by the electrical power generator being output to a power converter to convert the electrical power and to output converted electrical power.

The hybrid engine system of any preceding clause, the converted electrical power output by the power converter being input to a power distribution system, the power distribution system being configured to regulate and to distribute electrical power to equipment and systems in an aircraft.

Although the foregoing description is directed to the preferred embodiments of the present disclosure, other variations and modifications will be apparent to those skilled in the art and may be made without departing from the disclosure. Moreover, features described in connection with one embodiment of the present disclosure may be used in conjunction with other embodiments, even if not explicitly stated above.

1. A hybrid engine system comprising:
a turbine engine comprising a fan section, a compressor section, a combustion section, a turbine section, a shaft coupled to the compressor section, and a nacelle circumferentially surrounding the fan section, the fan section comprising at least one fan blade, the at least one fan blade comprising an upper portion and a lower portion;
a duct extending from the nacelle upstream of the fan section;
an electrical power generator mechanically coupled to the shaft, the electrical power generator being configured to convert at least a portion of mechanical power generated by the turbine engine into electrical power, the electrical power generator being positioned upstream from the fan section; and
a part-span inlet guide vane disposed between the duct and the nacelle, the part-span inlet guide vane including a plurality of inlet guide vanes that are configured to rotate between an open position and a closed position to adjust an amount of pressure of an airflow towards the fan section, wherein when the part-span inlet guide vane is in the closed position, a flow and pressure rise remains unchanged at the lower portion of the at least one fan blade.

2. The hybrid engine system of claim 1, wherein the turbine engine defines a longitudinal centerline axis and the electrical power generator is aligned with the longitudinal centerline axis.

3. The hybrid engine system of claim 1, wherein the electrical power generator is connected to the shaft via a transmission shaft.

4. The hybrid engine system of claim 1, wherein the shaft is a transmission shaft.

5. The hybrid engine system of claim 1, wherein the part-span inlet guide vane is configured to the closed position to reduce the amount of pressure of the airflow on the fan section to transfer power to the electrical power generator.

6. The hybrid engine system of claim 1, wherein the part-span inlet guide vane is configured to the open position to increase the amount of pressure of the airflow on the fan section to enable the turbine engine to generate thrust.

7. The hybrid engine system of claim 1, wherein the part-span inlet guide vane is disposed upstream of the fan section.

8. The hybrid engine system of claim 1, wherein the compressor section comprises a low-pressure compressor, the turbine section comprises a low-pressure turbine, and the fan section comprises a fan shaft, wherein the fan shaft is coupled to a low-pressure shaft, and the low-pressure shaft connects the low-pressure turbine to the low-pressure compressor to rotate the low-pressure turbine and the low-pressure compressor in unison.

9. The hybrid engine system of claim 1, wherein the shaft includes a fan shaft coupled to a fan in the fan section, and the electrical power generator is mechanically coupled to the fan shaft.

10. The hybrid engine system of claim 1, wherein the electrical power generator is configured to output at least a portion of the electrical power generated by the electrical power generator to charge one or more batteries.

11. The hybrid engine system of claim 1, further comprising a clutch provided between a fan of the fan section and the electrical power generator to couple the fan to the electrical power generator or to decouple the fan from the electrical power generator.

12. The hybrid engine system of claim 1, further comprising a gearbox provided between a fan of the fan section and the electrical power generator to enable rotating the electrical power generator at a different rotation speed than the fan.

13. The hybrid engine system of claim 1, wherein the fan section comprises a fan having a plurality of fan blades coupled to a disk in a spaced apart manner, wherein the disk is covered by a fan hub.

14. The hybrid engine system of claim 13, wherein the electrical power generator is located inside the fan hub, and the duct circumferentially surrounds the fan hub.

15. The hybrid engine system of claim 13, wherein the duct is supported by a plurality of circumferentially spaced outer vanes coupled to the fan hub.

16. The hybrid engine system of claim 1, wherein the electrical power generator is configured to output at least a portion of the electrical power generated by the electrical power generator to an electric motor.

17. The hybrid engine system of claim 16, wherein the electric motor is connected to equipment to operate the equipment.

18. The hybrid engine system of claim 17, wherein the equipment includes one or more fans, one or more aircraft systems, or one or more cooling systems, or any combination thereof.

19. The hybrid engine system of claim 18, wherein the electrical power generated by the electrical power generator is output to a power converter to convert the electrical power and to output converted electrical power.

20. The hybrid engine system of claim 19, wherein the converted electrical power that is output by the power converter is input to a power distribution system, the power distribution system being configured to regulate and to distribute electrical power to equipment and systems in an aircraft.
